(19) United States
(12) Patent Application Publication
(10) Pub. No.: US 2025/0306686 A1
(43) Pub. Date: Oct. 2, 2025

(54) Electrical Stimulation From A Wristband With Augmented Reality Visual Effects For Remote Haptic Sensations In The Hand, And Systems And Methods Of Use Thereof

(71) Applicant: Meta Platforms Technologies, LLC, Menlo Park, CA (US)

(72) Inventors: Yudai Tanaka, Redmond, WA (US); Neil Weiss, Seattle, WA (US); Brendan Patrick Flynn, Redmond, WA (US); Roger Boldu Busquets, Bellevue, WA (US)

(21) Appl. No.: 19/094,760

(22) Filed: Mar. 28, 2025

Related U.S. Application Data
(60) Provisional application No. 63/573,382, filed on Apr. 2, 2024.

(51) Int. Cl. G06F 3/01; G02B 27/01; G06F 1/16; G06V 40/20

(52) U.S. Cl. CPC G06F 3/016; G02B 27/0172; G06F 1/163; G06V 40/28; G02B 2027/0138; G02B 2027/014; G02B 2027/0178

(57) ABSTRACT

A method of providing remote haptic feedback is described. The method includes applying, via a set of electrodes of a wearable device, a haptic signal to a first portion of a user. The haptic signal is configured to cause haptic feedback to be perceived at a second portion of the user that is distinct from the first portion of the user. The method further includes causing a visual indication of the haptic feedback at the second portion to be displayed to the user via a display of a head-wearable device.

### PRIORITY AND RELATED APPLICATIONS

This application claims priority to U.S. Provisional Patent App. No. 63/573,382, filed Apr. 2, 2024, which is hereby incorporated by reference in its entirety.

### TECHNICAL FIELD

This relates generally to generating haptics, including but not limited to generating remote haptic sensations and displaying corresponding augmented-reality visual effects.

### BACKGROUND

Augmented-reality (AR) systems include wearable devices such as smart glasses, VR headsets, smartwatches, and controllers and are commonly equipped with technology configured to streamline a user's experience while interacting with the devices. Technology such as pass-through, mixed-reality, and augmented-reality have been implemented and improved in AR systems to allow for a more seamless user experience. However, integrated haptics and especially remote haptics (e.g., applying a signal at one part of the user's body and feeling a sensation at another part of body) have not been integrated into AR systems effectively to provide a seamless experience for users. As such, there is a need to address one or more of the above-identified challenges. A brief summary of solutions to the issues noted above are described below.

### SUMMARY

The systems and methods disclosed herein leverage remote haptic feedback paired with visual confirmation while a user is interacting with AR elements in an AR system. When interacting with AR objects (e.g., virtual objects) a user will often use their fingers. However, haptic systems on the users' fingers can be bulky and unwieldy, as well as being difficult and/or time consuming to put on and take off. These finger-based haptic systems may also interfere with the user's mobility when the user is attempting to grasp or manipulate the AR objects. Disclosed herein are systems and devices that generate (e.g., at a user's wrist) remote haptic signals (e.g., also sometimes referred to as stimuli) that are perceived at the user's finger(s) and/or palm. The remote haptic systems may be easier to put on and take off (e.g., slipping on a wristband) and do not interfere with the user's hand and finger movement. For example, while a user is wearing smart glasses and a smartwatch, and interacting with an AR object, the smartwatch can provide a haptic signal to the user's wrist that is perceived at another part of the user's hand such as the user's pointer finger. In conjunction with the remote haptic feedback, an indication can be displayed at the smart glasses that highlights the portion of the user's hand that is perceiving the haptic feedback (e.g., the user's pointer finger) such that the user is more mentally attuned to feeling the haptic sensation in the visually highlighted region. In this way, the remote haptic feedback may be perceived to be more localized to the intended region by the user. Additionally, a priming signal may be used to charge an area of the user's body prior to sending the remote haptic signal. This allows for a stronger remote haptic signal to be sent without causing discomfort to the user.

An example AR system may include one or more cameras, one or more displays (e.g., placed behind one or more lenses), and one or more programs, where the one or more programs are stored in memory and configured to be executed by one or more processors. The one or more programs include instructions for performing operations. The operations may include causing, via a set of electrodes of a wearable device, a haptic signal to be sent to a first portion of a user. The haptic signal may be configured to cause haptic feedback to be perceived at a second portion of the user that is distinct from the first portion of the user. The instructions may further include causing a visual indication of the haptic feedback at the second portion to be displayed to the user via a display of a head-wearable device. In some embodiments, the one or more processors are components of the wearable device and/or the head-wearable device.

As an illustrative example, suppose Sandra is wearing a head-wearable device (e.g., smart glasses, VR headset, etc.) and a wrist-wearable device (e.g., a smartwatch) while interacting with several menus within an AR environment. As Sandra is interacting with the menus that are visually displayed and she is performing in-air gestures and/or actions, without haptic or visual feedback it's challenging for her to confirm that her actions were properly detected. If while Sandra is pressing a virtual button in the AR environment, the wrist-wearable device provides a haptic sensation that activates the nerves in Sandra's fingertips, she then feels as though she is pressing a physical button. Additionally, if her finger in the AR environment lights up when she presses the button, there is further visual confirmation of her successfully pressing the button. Therefore, between the haptic sensations at her fingertip and the visual AR element confirming the press, Sandra's experience is more streamlined, reducing errors and providing a more intuitive man-machine interface.

Methods of providing remote haptic feedback are described. An example method includes applying, via a set of electrodes of a wearable device, a haptic signal to a first portion of a user. The haptic signal is configured to cause haptic feedback to be perceived at a second portion of the user that is distinct from the first portion of the user. The method further includes causing a visual indication of the haptic feedback at the second portion to be displayed to the user via a display of a head-wearable device.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of AR glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an XR headset. These methods and operations can be stored on a non-transitory computer-readable storage medium of a device or a system. It is also noted that the devices and systems described herein can be part of a larger, overarching system that includes multiple devices. A non-exhaustive list of electronic devices that can, either alone or in combination (e.g., a system), include instructions that cause the performance of methods and operations associated with the presentation and/or interaction with an XR experience include an XR headset (e.g., an MR headset or a pair of AR glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an XR system (i.e., the XR headset would be part of a system that includes one or more additional devices). Multiple combinations with different related devices are envisioned, but not recited for brevity.

The features and advantages described in the specification are not necessarily all-inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1D illustrate an example user scenario involving the user interacting with one or more AR elements, in accordance with some embodiments.

FIG. 2A illustrates a cross section of the user's wrist coupled to a plurality of electrodes of a wrist-wearable device in accordance with some embodiments.

FIGS. 2B-2C illustrate example electrical pulses generated by the wrist-wearable device and applied to the user's wrist in accordance with some embodiments.

FIG. 3 shows an example method flowchart for generating remote haptic sensations in accordance with some embodiments.

FIGS. 4A, 4B, 4C-1, and 4C-2 illustrate example MR and AR systems in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of XRs, such as MR and AR systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, for example, through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, “head-wearable device” or “headset device” as catchall terms that cover XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words, the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)) is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random-access memory (RAM), such as DRAM, SRAM, DDR RAM or other random-access solid-state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid-state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data, including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein, biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiogramar EKG) sensors configured to measure electrical activity of the heart to diagnose heart problems; (iii) EMG sensors configured to measure the electrical activity of muscles and diagnose neuromuscular disorders; and (iv) electrooculography (EOG) sensors configured to measure the electrical activity of eye muscles to detect eye movement and diagnose eye disorders.

As described herein, an application stored in the memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Remote Haptic Sensations

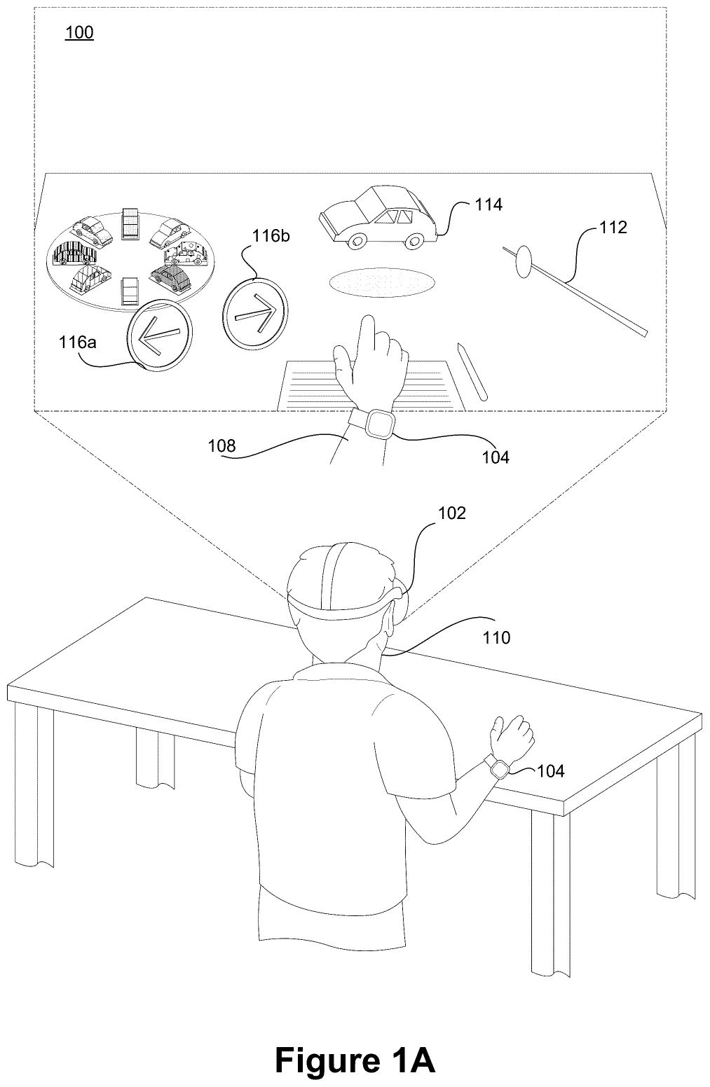

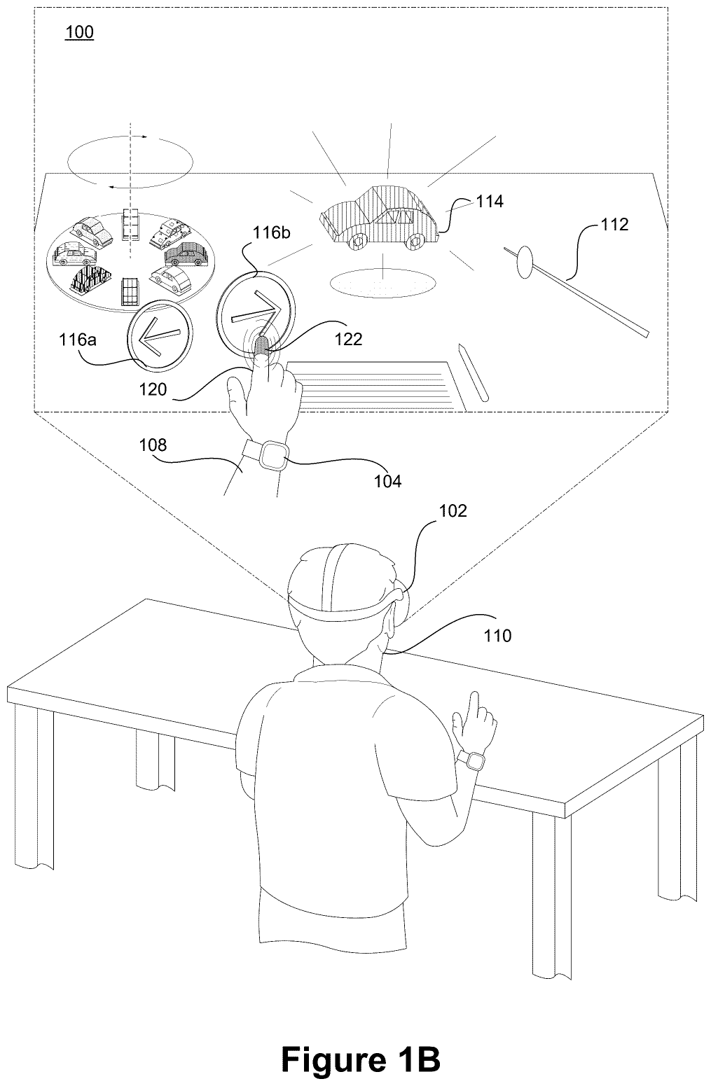

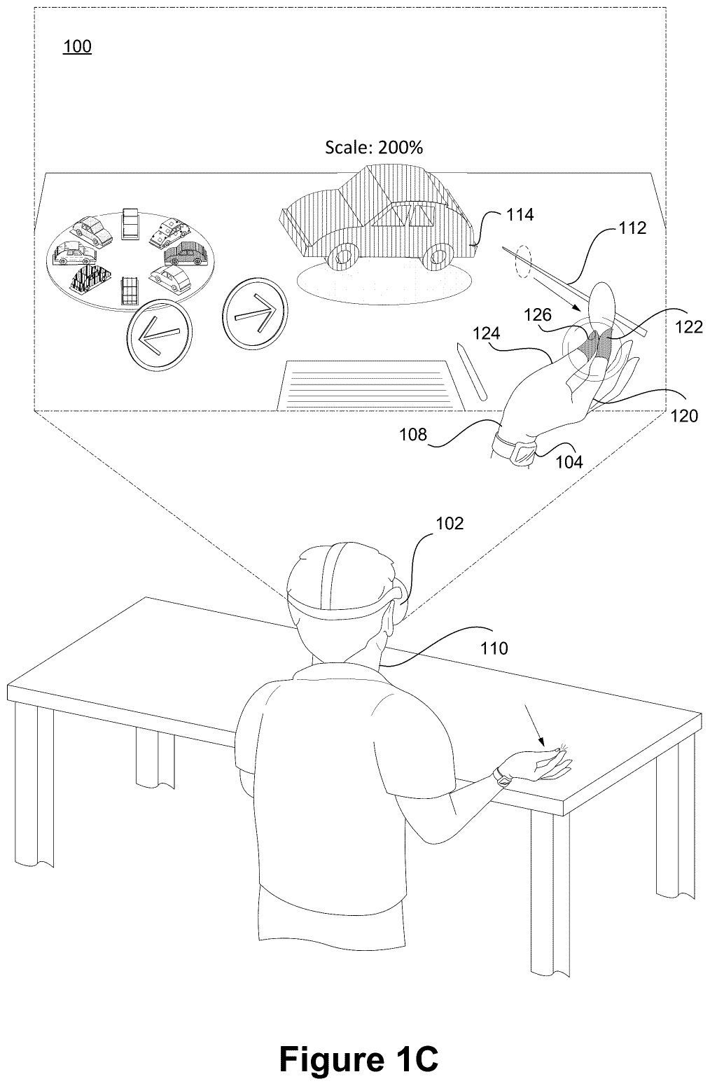

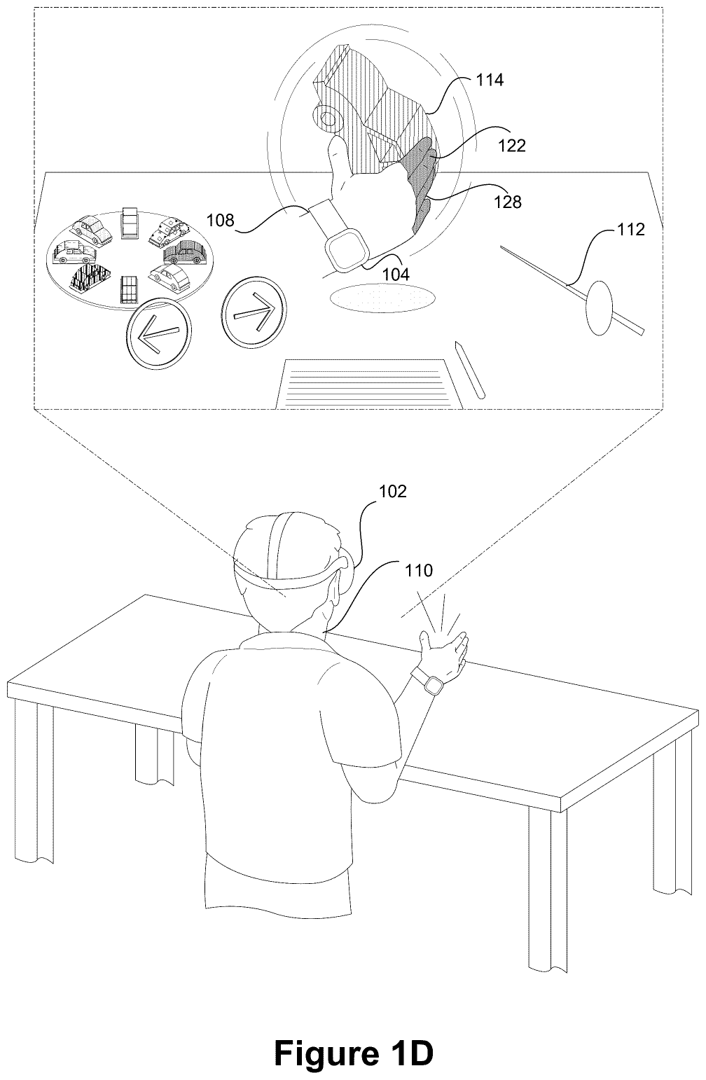

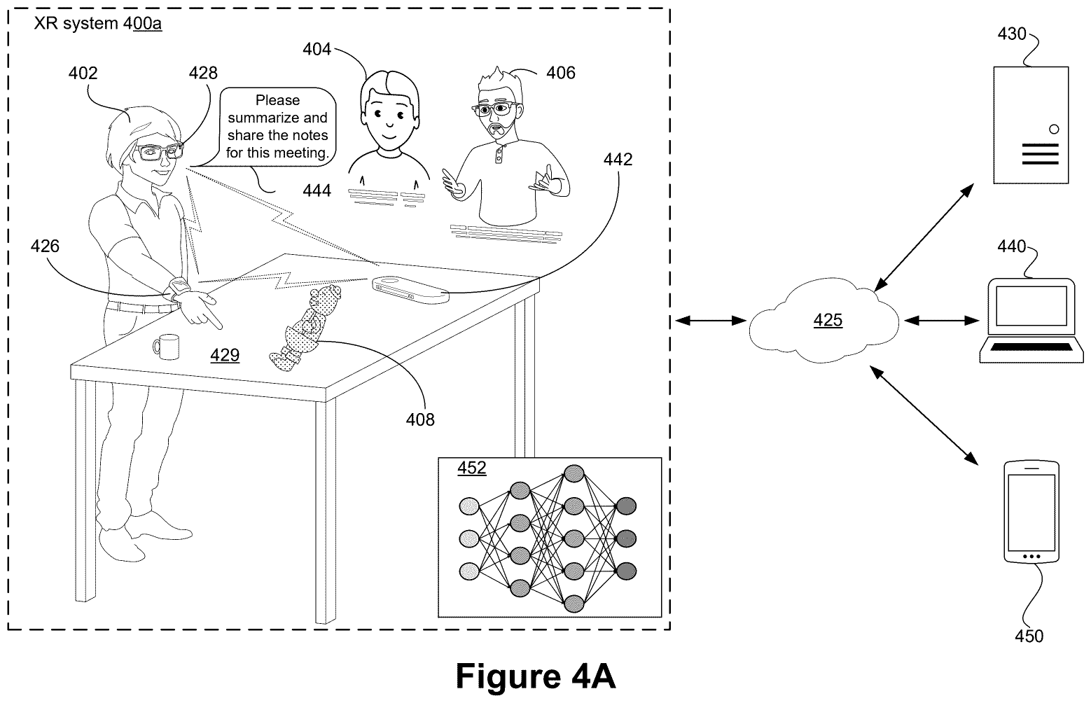

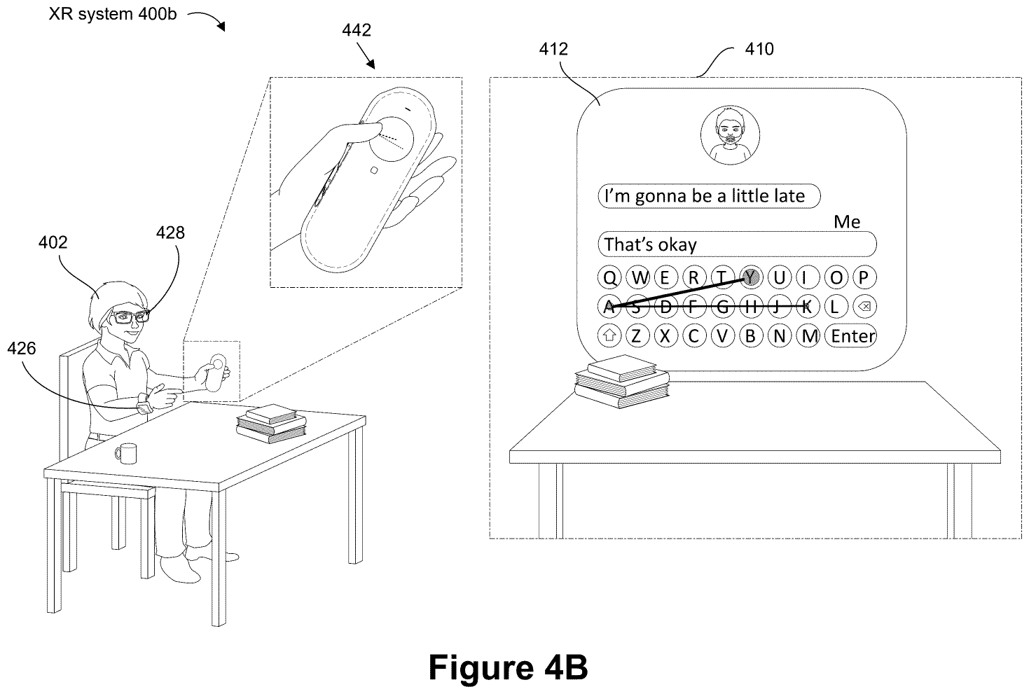

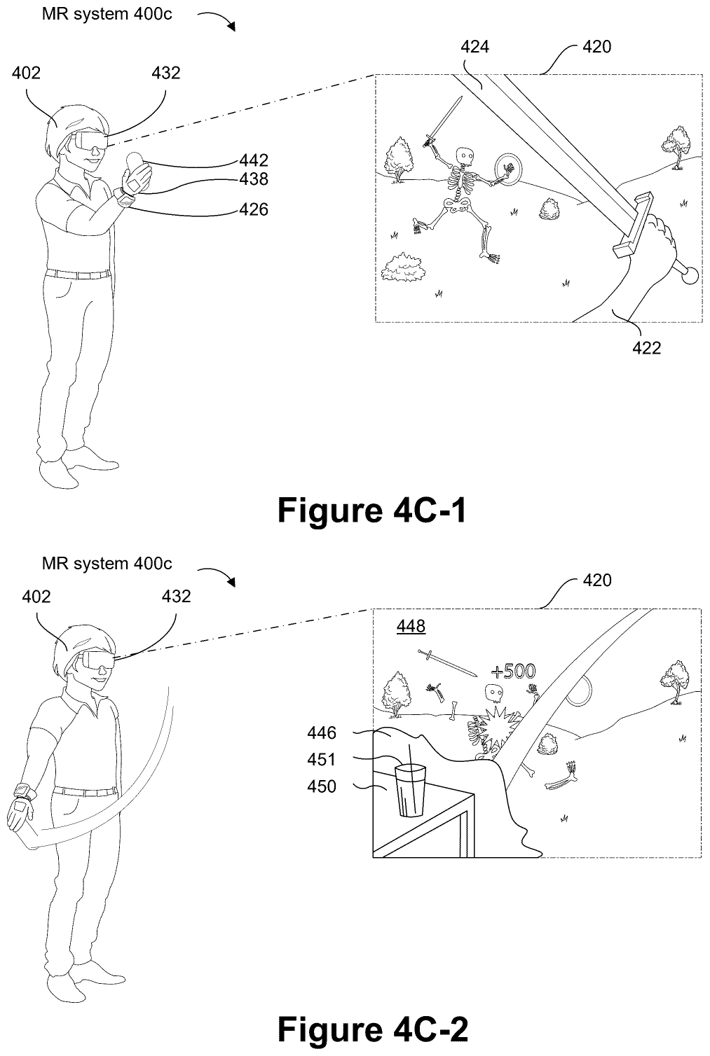

FIGS. 1A-1D illustrate an example user scenario involving the user interacting with one or more AR elements in accordance with some embodiments. A user 110 in FIG. 1A is wearing a head-wearable device 102 (e.g., an XR headset, AR glasses, smart glasses, etc.) and a wrist-wearable device 104 (e.g., a smartwatch and/or wristband). In some embodiments, the head-wearable device 102 is an instance of AR device 428 in FIG. 4A and the wrist-wearable device 104 is an instance of wrist-wearable device 426 in FIG. 4A. The user 110 in FIG. 1A is viewing a scene 100 that includes one or more AR elements (e.g., AR elements 112-116b) with which the user 110 can interact virtually. In some embodiments, the scene 100 is displayed on at least one lens of the head-wearable device 102. In some embodiments, the head-wearable device 102 is an MR device with a pass-through feature that allows the user 110 to see their hands and arms if they are within the field of view.

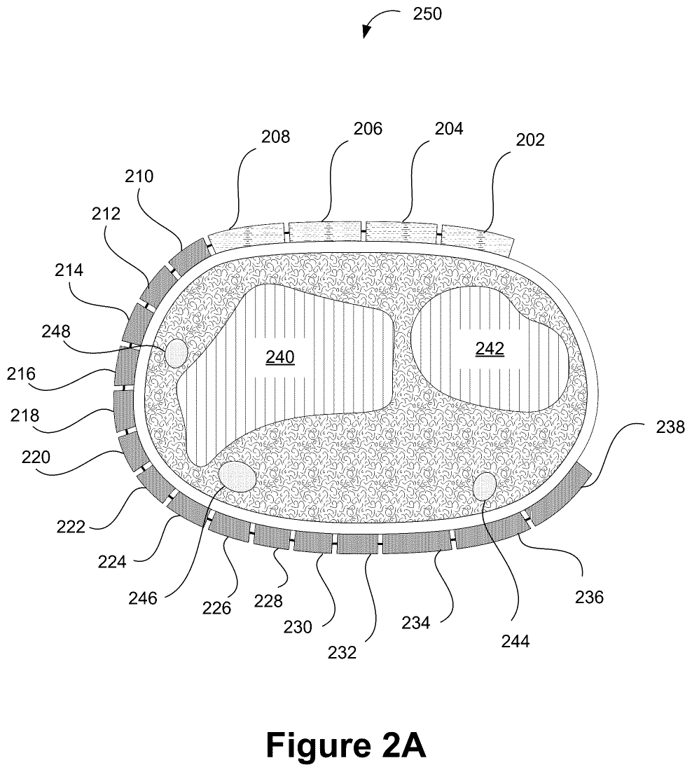

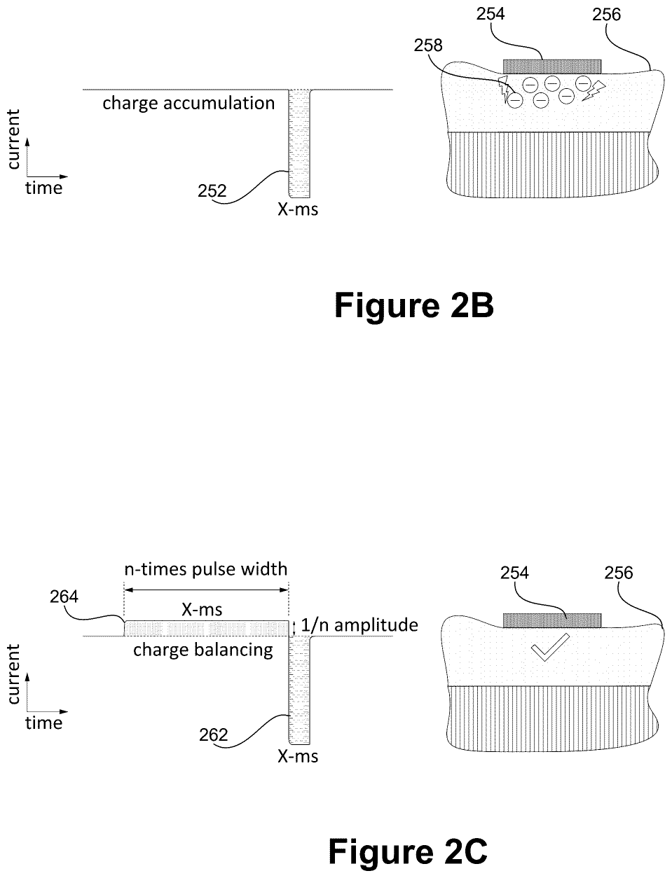

In some embodiments, the wrist-wearable device 104 includes a set of electrodes that are coupled to (or integrated with) a band portion of the wrist-wearable device 104 (and/or an underside of a capsule portion) in contact with the user's wrist 108 and configured to apply a haptic signal to the user's wrist 108. The haptic signal may be configured to cause haptic feedback to be perceived at another location on the user's hand (distinct from the user's wrist 108), such as a phalange of the user (e.g., the user's pointer finger, thumb, pinky, etc.). In some embodiments, the set of electrodes includes between 6 and 20 electrodes and are elastomeric dry electrodes. In some embodiments, the set of electrodes are arranged on a connector platform that is spring loaded such that the set of electrodes maintain contact with the user's wrist 108 while the wrist-wearable device 104 is worn. The set of electrodes are further discussed in FIG. 2A.

Some materials used to manufacture electrodes can irritate the user's skin (e.g., some electrically conductive materials such as copper). Thus, a material that is both conductive and not irritating to the skin is required. In some embodiments, each electrode in the set of electrodes is composed of a synthetic conductive elastomer. The synthetic conductive elastomer is configured to resist oxidation and have a first level of conductivity (e.g., equivalent or similar to the conductivity of copper). For example, an electrode made using the synthetic conductive elastomer has a high biocompatibility, which reduces oxidation. In some embodiments, the first level of conductivity is the same level of conductivity as provided by copper. In some embodiments, the synthetic conductive elastomer is configured to be chemically unreactive to skin contact.

In some embodiments, the haptic signal is an electrical current generated via one or more processors at the wrist-wearable device 104. The electrical current is in the range of 0.5-4 mA.

FIG. 1B illustrates the user 110 interacting with the virtual AR element 116b which is configured to move the plurality of items (e.g., the carousel of cars). FIG. 1B further illustrates the user 110 making a pointing motion and moving their hand into a location perceived by the system, including the head-wearable device 102 and the wrist-wearable device 104, as intersecting with the virtual AR element 116b. In accordance with a determination that the user's hand is positioned such that the AR element 116b is selected, the wrist-wearable device 104 is configured to generate a haptic signal that is applied to the user's wrist 108 via at least one of the electrodes within the set of electrodes such that the user 110 feels the haptic sensation at the portion of their body that intersects the virtual AR element 116b. For example, the user's right pointer finger 120 is intersecting with the virtual AR element 116b that is displayed to the user 110 in the scene 100. Thus, the user 110 will feel the haptic feedback sensation at their pointer finger 120 as opposed to the user's wrist 108 where the haptic signal is applied. Furthermore, in conjunction with the haptic signal, a visual indicator 122 (e.g., highlighting the user's pointer finger 120) is displayed to the user 110 overlaid with the portion of their body that is perceiving the haptic feedback. For example, as illustrated in FIG. 1B, the visual indicator 122 illustrates a portion of the user's pointer finger 120 highlighted with a visual indicator 122 to show the user 110 that they have successfully interacted with (e.g., placed their hand in a location that has intersected with) the virtual AR element 116b (e.g., selected/activated the virtual AR element 116b). In this way, when the user 110 interacts with the virtual AR element 112, a haptic signal is applied to the user's wrist 108, haptic feedback is perceived at the user's pointer finger 120, and the user's pointer finger 120 includes the visual indicator 122 (e.g., highlighting/glowing) displayed in the scene 100, confirming to the user 110 that the AR element 116b was selected. The virtual AR element 116b is displayed in contact with the phalange of the user 110 such that the haptic feedback maybe mentally associated with the touch of the virtual AR element 116b.

FIG. 1C illustrates the user 110 performing a pinch gesture in conjunction with another virtual AR element 112 (e.g., a sliding scale configured to scale the virtual AR element 114). FIG. 1C further illustrates multiple phalanges of the user 110 interacting with the virtual AR element 112. For example, the user 110 may be preparing to edit (e.g., color, reshape, etc.) the virtual AR element 114 and wants to enlarge it so he can view and edit details more clearly. Thus, the user 110 performs a gesture with his hand while a portion of the user's hand is interacting with the virtual AR element 112 and the wrist-wearable device 104 provides another haptic feedback signal to the user 110. FIG. 1C illustrates the user's thumb 124 and the user's pointer finger 120 interacting with the virtual AR element 112, and the wrist-wearable device 104 may provide the haptic signal to the user's wrist 108 such that the haptic feedback sensation is perceived at the user's thumb 124 and the user's pointer finger 120. In accordance with some embodiments, the head-wearable device 102 provides a visual indicator 122 and another visual indicator 126 highlighting the portions of the user's fingers that are perceiving the haptic feedback and intersecting with the virtual AR element 112. In some embodiments, the haptic signal configured to be perceived in the user's thumb 124 is applied to the user's wrist 108 using a different set of electrodes than the electrodes used to provide the haptic signal configured to be perceived in the user's pointer finger 120. If the user 110 was not in proximity to the virtual AR element 112 (e.g., the user's hand was not intersecting with the virtual AR element 112) and the user 110 performed the same (pinch) gesture, the user 110 would neither receive the haptic signal nor the visual indicator 122 or 126 (e.g., indicating that the gesture was not successful because the user was not interacting with an AR element when performing the gesture).

FIG. 1D illustrates the user 110 interacting with the virtual AR element 114. In some embodiments, when portions of the user's hand 128 interact with the virtual AR element 114, respective portions of the user's hand perceive haptic feedback. As illustrated in FIG. 1D, a visual indicator 122 highlights the portions of the user's hand 130 that are interacting with the virtual AR element 114 and perceive haptic feedback. Haptic signals may be generated by the wrist-wearable device 104, applied to the user's wrist 108, and perceived at the respective portions of the user's hand 128 as described previously with respect to FIGS. 1B and 1C.

FIG. 2A illustrates a cross section of the user's wrist 250 coupled to a plurality of electrodes of a wrist-wearable device in accordance some embodiments. FIG. 2A illustrates electrodes 202-238, the user's ulna bone 242, the user's radius bone 240, and corresponding nerves including the ulnar nerve 244, the median nerve 246, and the radial nerve 248. In some embodiments, the set of electrodes 202-208 are designated as base electrodes and the set of electrodes 210-238 are designated as stimulation electrodes. During operation, electrical current flows between at least one simulation electrode and at least one base electrode. For example, the one or more processors of the wrist-wearable device cause generation of electrical current that is applied to the user's skin via the stimulation electrode(s). In accordance with a determination that a haptic signal be applied to the user, at least one stimulation electrode is activated, such that the electrical current is applied to a set of nerves to stimulate haptic feedback at a remote part of the user's hand (e.g., the user's thumb and/or pointer finger). By activating different stimulation electrodes, the wrist-wearable device can stimulate different regions of the user's nerve, which innervate different remote portions of the user's body (e.g., different fingers of the user's hand). In some embodiments, the set of electrodes 210-238 are positioned over the nerves innervating receptors populating the palmar side of the hand (e.g., median and ulnar). In some embodiments, one or more of the electrodes (e.g., the electrodes 216-232) are designed to be smaller and more densely distributed, which can allow for finer adjustment of the stimulation point. For example, an electrical current applied via the electrodes surrounding the median nerve (e.g., electrodes 222-226) can be used to activate haptic feedback sensations in the user's thumb and pointer finger. In some embodiments, the base electrodes include anodic electrodes and the stimulation electrodes include cathodic electrodes.

In some embodiments, the first portion of the user's hand (e.g., the wrist of the user) is connected with the second portion of the user's hand (e.g., the thumb/pointer finger) via a muscle group and nerve system. Thus, when a haptic signal is applied to the user's wrist, the muscle group and/or nerves is able to transmit that electrical current, and haptic feedback is interpreted as being felt at the user's thumb and/or pointer finger. For example, the haptic signal applied to the user's wrist is received by the nervous system and interpreted by the user's spine and brain such that the user perceives feeling the sensation remotely from where it was applied (e.g., perceived at the user's hand instead of the user's wrist).

FIGS. 2B-2C illustrate example electrical pulses (e.g., pulse 252, priming pulse 264, and pulse 262) generated by the wrist-wearable device and applied to the user's wrist, in some embodiments. Haptic feedback can cause irritation of the user's skin 256. By using the pulse 252 illustrated in FIG. 2B, the electrical current flows between the electrodes (e.g., electrode 254) building up a charge of electrons 258, which can irritate the user's skin 256. Haptic signals (e.g., anodic stimulation) can produce additional tactile sensations directly underneath the electrodes. For example, as shown in FIG. 2B the tactile sensation would be on the user's wrist. This sensation is undesirable as it could distract the user from the finger-oriented feedback. This irritation can be prevented and/or reduced by applying a priming pulse (e.g., the priming pulse 264; FIG. 2C) with opposite polarity of the haptic feedback pulse. Applying the priming pulse balances the electron flow between the two polarities and reduces/prevents the charge accumulation on the skin (FIG. 2C).

FIG. 2C illustrates an asymmetric stimulation waveform similar to biphasic stimulation, where each a cathodic pulse (e.g., pulse 262 of 5-ms) is paired with a priming pulse (e.g., priming pulse 264 of 40-ms) of the opposite polarity. Compared to the stimulation pulse (e.g., pulse 262), the priming pulse has only a fraction of (e.g., one-eighth) the amplitude, but its pulse width is longer (e.g., by eight times). Thus, while balancing out the overall charge to prevent skin irritation, the lower amplitude of the priming pulse generates minimal tactile sensations at the user's wrist.

In some embodiments, the electrical pulses generated by the wrist-wearable device are configured to provide local haptic feedback to the user's wrist such that the user perceives the haptic feedback at their wrist. When applying the haptic signals to the wrist intended to generate a sensation at the user's wrist, the processors at the wrist-wearable device can select the respective electrodes configured to generate the haptic signal that will be perceived locally (e.g., avoid stimulating the user's nerves). For example, the wrist-wearable device can activate a first set of electrodes configured to provide remote haptic feedback and activate another set of electrodes to provide haptic feedback locally at the user's wrist.

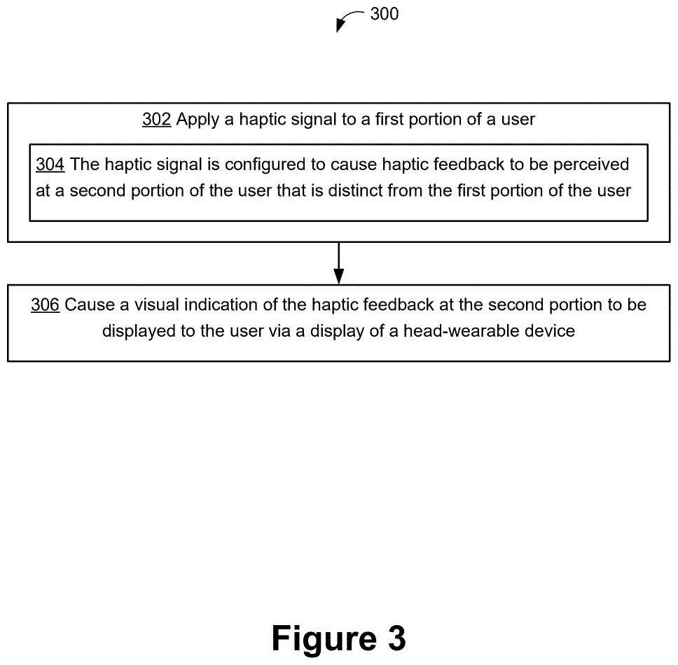

FIG. 3 illustrates a flow diagram of a method 300 of generating remote haptic sensations, in accordance with some embodiments. Operations (e.g., steps) of the method 300 can be performed by one or more processors (e.g., central processing unit and/or MCU) of a system including a head-wearable device 102 and a wrist-wearable device 104. At least some of the operations shown in FIG. 3 correspond to instructions stored in a computer memory or computer-readable storage medium (e.g., storage, RAM, and/or memory) of the head-wearable device 102 and the wrist-wearable device 104. Operations of the method 300 can be performed by a single device alone or in conjunction with one or more processors and/or hardware components of another communicatively coupled device (e.g., the head-wearable device 102 and the wrist-wearable device 104) and/or instructions stored in memory or computer-readable medium of the other device communicatively coupled to the head-wearable device 102 and/or the wrist-wearable device 104. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device but should not be construed as limiting the performance of the operation to the particular device in all embodiments.

(A1) FIG. 3 shows a flowchart of a method 300 for generating remote haptic sensations, in accordance with some embodiments. The method 300 includes, applying (302), via a set of electrodes (e.g., 218-228) of a wearable device, a haptic signal to a first portion of a user (e.g., user 110). As illustrated in FIGS. 1A-1D, the user 110 is wearing a wrist-wearable device 104 coupled to the first portion of the user 110 including the user's wrist 108.

The method further includes causing (304) haptic feedback to be perceived at a second portion of the user (e.g., the user's pointer finger 120) that is distinct from the first portion of the user (e.g., the user's wrist 108). For example, as illustrated in FIG. 1B, the haptic feedback is perceived at the user's pointer finger 120 (e.g., the second portion of the user 110) after the haptic signal is received at the first portion of the user 110 (e.g., the user's wrist 108).

The method further includes causing (306) a visual indication (e.g., visual indicator 122) of the haptic feedback at the second portion to be displayed to the user via a display of a head-wearable device. In some embodiments, the visual indicator 122 is displayed in the scene 100.

(A2) In some embodiments of A1, the method further includes, prior to applying the haptic signal, applying a priming signal (e.g., priming pulse 264) to the first portion of the user (e.g., the user's wrist 108), where the priming signal is configured to be imperceptible to the user. In some embodiments, the priming pulse 264 is intended to be opposite the pulse signal 262 such that there is no charge accumulating on the user's skin as described in FIG. 2C.

(A3) In some embodiments of any of A2, the priming signal (e.g., the priming pulse 264) has an opposite polarity as the haptic signal (e.g., pulse 262). FIG. 2C illustrates the priming pulse 264 and the pulse signal 262 (e.g., the haptic signal).

(A4) In some embodiments of any of A1-A3, the method further includes applying, via the set of electrodes (e.g., electrodes 210-238) of the wearable device (e.g., wrist-wearable device 104), a second haptic signal to the first portion of a user, wherein the second haptic signal is configured to cause second haptic feedback to be perceived at a third portion of the user (e.g., the user's thumb 124) that is distinct from the first portion of the user (e.g., the user's wrist 108) and the second portion of the user (e.g., the user's pointer finger 120). In some embodiments, an additional haptic signal is applied to the user's wrist 108 configured to provide the user 110 with haptic feedback in their thumb 124.

(B1) In accordance with some embodiments, a system including a wearable device (e.g., wrist-wearable device 104) that includes a set of electrodes that are configured to contact a first portion (e.g., the user's wrist 108) of a user while the wearable device is being worn by the user and apply a haptic signal to a first portion of a user. The haptic signal is configured to cause haptic feedback to be perceived at a second portion of the user that is distinct from the first portion of the user. The system further includes a head-wearable device configured to provide an indication to the user that the haptic feedback is to be perceived at the second portion of the user.

In some embodiments, the set of electrodes comprises a set of elastomeric dry electrodes. In some embodiments, the set of electrodes comprises between 6 and 20 (e.g., 15) electrodes. In some embodiments, each electrode of the set of electrodes is arranged on a connector platform (e.g., a spring-loaded platform) configured to maintain contact with the first portion of the user while the wearable device is being worn. In some embodiments, the head-wearable device comprises an XR headset. In some embodiments, the head-wearable device comprises a pair of glasses (e.g., AR glasses). In some embodiments, the wearable device is a wrist-wearable device (e.g., a smartwatch or wristband). In accordance with some embodiments, a wearable device includes a set of electrodes and is configured to (i) apply a haptic signal to a first portion of a user, wherein the haptic signal is configured to cause haptic feedback to be perceived at a second portion of the user that is distinct from the first portion of the user, and (ii) cause visual feedback to be presented to the user, the visual feedback indicating the second portion of the user.

(B2) In some embodiments of B1, the haptic signal includes a first subsignal (e.g., the priming pulse 264) having a first polarity, a first amplitude, and a first length. The haptic signal further includes a second subsignal (e.g., the pulse 262) having a second polarity, the second polarity opposite the first polarity, a second amplitude, the second amplitude larger than the first amplitude, and a second length, the second length shorter than the first length. In some embodiment, the priming pulse 264 is sent after the pulse 262. For example, sending a single pulse 262 may not irritate a user's skin, but multiple pulses 262 may cause discomfort due to charge buildup. In some embodiments, a priming pulse (e.g., a recovery pulse) sent after a pulse 262 to reduce charge buildup (e.g., pulses can alternate between pulses and recovery pulses). In some embodiments, a priming pulse is sent after a set number of pulses (e.g., after every 2 or 3 regular pulses). As mentioned above, in some circumstances a single remote signal will not cause irritation at wrist of a user, however, repeated pulses will cause irritation to the user's wrist unless a priming pulse or a recovery pulse is generated between each respective pulse 262. Applying a current to the user's skin repeatedly allows the charge on the skin to build up and can provide an unpleasant local sensation at the user's wrist. This is undesirable/uncomfortable for the user and may confuse the user as to where the haptic feedback is intended be felt. Thus, applying the charge balancing technique described above allows the haptic feedback to be perceived by the user at the intended location without discomfort.

In some embodiments, the first subsignal (e.g., the priming pulse 264) comprises a first set of one or more pulses. In some embodiments, the second subsignal (e.g., the pulse 262) comprises a second set of one or more pulses. In some embodiments, the first amplitude is less than half of the second amplitude (e.g., ¼, ⅓, ⅙, or ⅛). In some embodiments, the first length is at least twice the second length (e.g., 3×, 4×, 6×, or 8× the first length). In some embodiments, the haptic signal comprises an asymmetric waveform composed of the first subsignal and the second subsignal. As an example, the first subsignal may have a duration of 30-60 (e.g., 40) milliseconds, whereas the second subsignal may have a duration of 1-10 (e.g., 5) milliseconds.

(B3) In some embodiments of B2, the first subsignal is configured to be imperceptible by the user. For example, the first subsignal has an amplitude that is less than a perceptible threshold. As an example, the first subsignal may be a priming signal (e.g., a priming pulse). In some embodiments, the first subsignal is configured to be below a sensation threshold of the user. In some embodiments, the first subsignal is configured to accumulate a charge at the first portion of the user (e.g., a negative charge). This is further discussed in FIGS. 2B-2C.

(B4) In some embodiments of B3, the second subsignal is configured to be perceptible by the user. For example, the second subsignal may be irritating to the user if not preceded by the first subsignal. As an example, the second subsignal may be a stimulation signal (e.g., a stimulation pulse).

(B5) In some embodiments of any of B1-B4, the haptic signal is an electrical current generated at the wearable device. For example, the electrical current may be in the range of 0.5-4 milliamperes.

(B6) In some embodiments of any of B1-B5, the first portion of the user corresponds to a wrist of the user. The second portion of the user corresponds to a hand of the user. For example, the haptic signal is provided at the user's wrist and is perceived at the user's finger. In some embodiments, the first portion is physically coupled to the second portion of the user via a muscle group of the user. In some embodiments, the first portion of the user is the user's wrist and the second portion of the user is at least one of the user's phalange (e.g., thumb or pointer finger) or the user's palm.

(B7) In some embodiments of any of B1-B6, the head-wearable device further includes a display, and the indication provided to the user is an interface element displayed via the display of the head-wearable device. For example, a virtual object is displayed in contact with the second portion of the user such that the haptic feedback may be mentally associated with the touch of the virtual object.

(B8) In some embodiments of B7, the first portion of the user and the second portion of the user are displayed on the display of the wearable device and the indication is positioned to visually overlap with the second portion of the user. For example, the head-wearable device may be an MR device with a pass-through feature that allows the user to see their hands and arms (if in the field of view). In this example, the indication may be displayed on top of the portion intended to perceive the haptic feedback (e.g., the second portion).

(B9) In some embodiments of any of B1-B8, each electrode of the set of electrodes is composed of a synthetic conductive elastomer. In some embodiments, each electrode is configured to resist oxidation and have a first level of conductivity. For example, an electrode may be composed of a synthetic conductive elastomer having a high biocompatibility (to reduce oxidation). In some embodiments, the first level of conductivity is a same level of conductivity as copper has. In some embodiments, the synthetic conductive elastomer is configured to be chemically unreactive to skin contact.

(B10) In some embodiments of any of B1-B9, the set of electrodes are arranged and configured to selectively apply haptic signals to respective nerves of a set of nerves of the user. For example, as shown in FIG. 2A, one or more electrodes are strategically placed around each respective nerve to provide the best contact for remote haptic sensations. For example, the set of electrodes may include one or more electrodes configured to apply haptic signals to each of an ulnar nerve, a median nerve, and a radial nerve (e.g., 1-5 electrodes for each nerve). In some embodiments, the set of electrodes comprises a set of base electrodes and a set of stimulation electrodes, where the stimulation electrodes are positioned to apply electrical currents to a set of nerves and the base electrodes are configured to receive the electrical currents (e.g., act as electrical grounds). In some embodiments, the base electrodes comprise anodic electrodes and the stimulation electrodes comprise cathodic electrodes.

(B11) In some embodiments of B10, the set of electrodes comprises electrodes having differing sizes. For example, the base electrodes may be larger than the stimulation electrodes. In some embodiments, the size of each electrode is based on a corresponding portion of a user's body. For example, electrodes configured to stimulate a radial nerve may be smaller than electrodes configured to stimulate a median nerve or ulnar nerve.

(B12) In some embodiments of any of B1-B11, the wearable device is further configured to apply, via the set of electrodes, a second haptic signal to the first portion of a user, wherein the second haptic signal is configured to cause a second haptic feedback to be perceived at a third portion of the user that is distinct from the first portion of the user and the second portion of the user. In some embodiments, the second haptic signal is applied by a different subset of electrodes than the (first) haptic signal.

(B13) In some embodiments of any of B1-B12, the wearable device is configured to apply the haptic signal in response to a determination that the second portion of the user intersects with a virtual object.

(C1) In accordance with some embodiments, a non-transitory computer-readable storage medium storing one or more programs executable by one or more processors, the one or more programs comprising instructions for applying, via a set of electrodes of a wearable device, a haptic signal to a first portion of a user. The haptic signal is configured to cause haptic feedback to be perceived at a second portion of the user that is distinct from the first portion of the user. The instructions further include causing a visual indication of the haptic feedback at the second portion to be displayed to the user via a display of a head-wearable device. In some embodiments, the one or more processors are components of the wearable device.

(C2) In some embodiments of C1, prior to applying the haptic signal, displaying, via the display of the head-wearable device, a virtual object. In some embodiments, the haptic signal is applied to the first portion of the user in accordance with a determination that the second portion of the user's hand (e.g., or a virtual representation of the user's hand) intersects with the virtual object. For example, the virtual object may be a virtual surface of a virtual button or other type of virtual object (e.g., a coffee mug, a handle, or other type of virtual object). In some embodiments, the virtual object is stationary, and the user moves to touch the virtual object (e.g., reaches for the virtual object). In some embodiments, the virtual object is mobile, and movement of the virtual object causes the virtual object to intersect with the user's hand (or other body party).

(C3) In some embodiments of C2, the instructions further include in accordance with a determination that the user is grasping the virtual object using a first finger corresponding to the second portion of the user's hand and a thumb corresponding to a third portion of the user's hand, applying a second haptic signal to the first portion of the user. In some embodiments, the second haptic signal is configured to cause second haptic feedback to be perceived at the third portion of the user. The instructions further include causing a second visual indication of the second haptic feedback at the third portion to be displayed to the user via the display of the head-wearable device. In some embodiments, the second haptic signal is applied to a different nerve than the first haptic signal. In some embodiments, the second haptic signal is applied to a same nerve as the first haptic signal, but from a different direction such that the second haptic signal is perceived differently than the first haptic signal.

### Example Extended-Reality Systems

FIGS. 4A, 4B, 4C-1, and 4C-2, illustrate example XR systems that include AR and MR systems, in accordance with some embodiments. FIG. 4A shows a first XR system 400a and first example user interactions using a wrist-wearable device 426, a head-wearable device (e.g., AR device 428), and/or a HIPD 442. FIG. 4B shows a second XR system 400b and second example user interactions using a wrist-wearable device 426, AR device 428, and/or an HIPD 442. FIGS. 4C-1 and 4C-2 show a third MR system 400c and third example user interactions using a wrist-wearable device 426, a head-wearable device (e.g., an MR device such as a VR device), and/or an HIPD 442. As the skilled artisan will appreciate upon reading the descriptions provided herein, the above-example AR and MR systems (described in detail below) can perform various functions and/or operations.

The wrist-wearable device 426, the head-wearable devices, and/or the HIPD 442 can communicatively couple via a network 425 (e.g., cellular, near field, Wi-Fi, personal area network, wireless LAN). Additionally, the wrist-wearable device 426, the head-wearable device, and/or the HIPD 442 can also communicatively couple with one or more servers 430, computers 440 (e.g., laptops, computers), mobile devices 450 (e.g., smartphones, tablets), and/or other electronic devices via the network 425 (e.g., cellular, near field, Wi-Fi, personal area network, wireless LAN). Similarly, a smart textile-based garment, when used, can also communicatively couple with the wrist-wearable device 426, the head-wearable device(s), the HIPD 442, the one or more servers 430, the computers 440, the mobile devices 450, and/or other electronic devices via the network 425 to provide inputs.

Turning to FIG. 4A, a user 402 is shown wearing the wrist-wearable device 426 and the AR device 428 and having the HIPD 442 on their desk. The wrist-wearable device 426, the AR device 428, and the HIPD 442 facilitate user interaction with an AR environment. In particular, as shown by the first XR system 400a, the wrist-wearable device 426, the AR device 428, and/or the HIPD 442 cause presentation of one or more avatars 404, digital representations of contacts 406, and virtual objects 408. As discussed below, the user 402 can interact with the one or more avatars 404, digital representations of the contacts 406, and virtual objects 408 via the wrist-wearable device 426, the AR device 428, and/or the HIPD 442. In addition, the user 402 is also able to directly view physical objects in the environment, such as a physical table 429, through transparent lens(es) and waveguide(s) of the AR device 428. Alternatively, an MR device could be used in place of the AR device 428 and a similar user experience can take place, but the user would not be directly viewing physical objects in the environment, such as table 429, and would instead be presented with a virtual reconstruction of the table 429 produced from one or more sensors of the MR device (e.g., an outward facing camera capable of recording the surrounding environment).

The user 402 can use any of the wrist-wearable device 426, the AR device 428 (e.g., through physical inputs at the AR device and/or built-in motion tracking of a user's extremities), a smart-textile garment, externally mounted extremity tracking device, the HIPD 442 to provide user inputs, etc. For example, the user 402 can perform one or more hand gestures that are detected by the wrist-wearable device 426 (e.g., using one or more EMG sensors and/or IMUs built into the wrist-wearable device) and/or AR device 428 (e.g., using one or more image sensors or cameras) to provide a user input. Alternatively, or additionally, the user 402 can provide a user input via one or more touch surfaces of the wrist-wearable device 426, the AR device 428, and/or the HIPD 442, and/or voice commands captured by a microphone of the wrist-wearable device 426, the AR device 428, and/or the HIPD 442. The wrist-wearable device 426, the AR device 428, and/or the HIPD 442 include an artificially intelligent digital assistant to help the user in providing a user input (e.g., completing a sequence of operations, suggesting different operations or commands, providing reminders, confirming a command). For example, the digital assistant can be invoked through an input occurring at the AR device 428 (e.g., via an input at a temple arm of the AR device 428). In some embodiments, the user 402 can provide a user input via one or more facial gestures and/or facial expressions. For example, cameras of the wrist-wearable device 426, the AR device 428, and/or the HIPD 442 can track the user 402's eyes for navigating a user interface.

The wrist-wearable device 426, the AR device 428, and/or the HIPD 442 can operate alone or in conjunction to allow the user 402 to interact with the AR environment. In some embodiments, the HIPD 442 is configured to operate as a central hub or control center for the wrist-wearable device 426, the AR device 428, and/or another communicatively coupled device. For example, the user 402 can provide an input to interact with the AR environment at any of the wrist-wearable device 426, the AR device 428, and/or the HIPD 442, and the HIPD 442 can identify one or more back-end and front-end tasks to cause the performance of the requested interaction and distribute instructions to cause the performance of the one or more back-end and front-end tasks at the wrist-wearable device 426, the AR device 428, and/or the HIPD 442. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 442 can perform the back-end tasks and provide the wrist-wearable device 426 and/or the AR device 428 operational data corresponding to the performed back-end tasks such that the wrist-wearable device 426 and/or the AR device 428 can perform the front-end tasks. In this way, the HIPD 442, which has more computational resources and greater thermal headroom than the wrist-wearable device 426 and/or the AR device 428, performs computationally intensive tasks and reduces the computer resource utilization and/or power usage of the wrist-wearable device 426 and/or the AR device 428.

In the example shown by the first XR system 400a, the HIPD 442 identifies one or more back-end tasks and front-end tasks associated with a user request to initiate an AR video call with one or more other users (represented by the avatar 404 and the digital representation of the contact 406) and distributes instructions to cause the performance of the one or more back-end tasks and front-end tasks. In particular, the HIPD 442 performs back-end tasks for processing and/or rendering image data (and other data) associated with the AR video call and provides operational data associated with the performed back-end tasks to the AR device 428 such that the AR device 428 performs front-end tasks for presenting the AR video call (e.g., presenting the avatar 404 and the digital representation of the contact 406).

In some embodiments, the HIPD 442 can operate as a focal or anchor point for causing the presentation of information. This allows the user 402 to be generally aware of where information is presented. For example, as shown in the first XR system 400a, the avatar 404 and the digital representation of the contact 406 are presented above the HIPD 442. In particular, the HIPD 442 and the AR device 428 operate in conjunction to determine a location for presenting the avatar 404 and the digital representation of the contact 406. In some embodiments, information can be presented within a predetermined distance from the HIPD 442 (e.g., within five meters). For example, as shown in the first XR system 400a, virtual object 408 is presented on the desk some distance from the HIPD 442. Similar to the above example, the HIPD 442 and the AR device 428 can operate in conjunction to determine a location for presenting the virtual object 408. Alternatively, in some embodiments, presentation of information is not bound by the HIPD 442. More specifically, the avatar 404, the digital representation of the contact 406, and the virtual object 408 do not have to be presented within a predetermined distance of the HIPD 442. While an AR device 428 is described working with an HIPD, an MR headset can be interacted with in the same way as the AR device 428.

User inputs provided at the wrist-wearable device 426, the AR device 428, and/or the HIPD 442 are coordinated such that the user can use any device to initiate, continue, and/or complete an operation. For example, the user 402 can provide a user input to the AR device 428 to cause the AR device 428 to present the virtual object 408 and, while the virtual object 408 is presented by the AR device 428, the user 402 can provide one or more hand gestures via the wrist-wearable device 426 to interact and/or manipulate the virtual object 408. While an AR device 428 is described working with a wrist-wearable device 426, an MR headset can be interacted with in the same way as the AR device 428.

### Integration of Artificial Intelligence With XR Systems

FIG. 4A illustrates an interaction in which an artificially intelligent virtual assistant can assist in requests made by a user 402. The AI virtual assistant can be used to complete open-ended requests made through natural language inputs by a user 402. For example, in FIG. 4A the user 402 makes an audible request 444 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 4A also illustrates an example neural network 452 used in Artificial Intelligence applications. Uses of Artificial Intelligence (AI) are varied and encompass many different aspects of the devices and systems described herein. AI capabilities cover a diverse range of applications and deepen interactions between the user 402 and user devices (e.g., the AR device 428, an MR device 432, the HIPD 442, the wrist-wearable device 426). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 402 can interact with an AI model through natural language inputs captured by a voice sensor, text inputs, or any other input modality that accepts natural language and/or a corresponding voice sensor module. In another instance, input is provided by tracking the eye gaze of a user 402 via a gaze tracker module. Additionally, the AI model can also receive inputs beyond those supplied by a user 402. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 428) or from multiple devices that are in communication with each other (e.g., a system that includes at least two of an AR device 428, an MR device 432, the HIPD 442, the wrist-wearable device 426, etc.). The AI model can also access additional information (e.g., one or more servers 430, the computers 440, the mobile devices 450, and/or other electronic devices) via a network 425.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 428, an MR device 432, the HIPD 442, the wrist-wearable device 426) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 428, an MR device 432, the HIPD 442, the wrist-wearable device 426), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 442), haptic feedback can provide information to the user 402. An AI model can also use the inputs described above to determine the appropriate modality and device(s) to present content to the user (e.g., a user walking on a busy road can be presented with an audio output instead of a visual output to avoid distracting the user 402).

### Example Augmented Reality Interaction

FIG. 4B shows the user 402 wearing the wrist-wearable device 426 and the AR device 428 and holding the HIPD 442. In the second XR system 400b, the wrist-wearable device 426, the AR device 428, and/or the HIPD 442 are used to receive and/or provide one or more messages to a contact of the user 402. In particular, the wrist-wearable device 426, the AR device 428, and/or the HIPD 442 detect and coordinate one or more user inputs to initiate a messaging application and prepare a response to a received message via the messaging application.

In some embodiments, the user 402 initiates, via a user input, an application on the wrist-wearable device 426, the AR device 428, and/or the HIPD 442 that causes the application to initiate on at least one device. For example, in the second XR system 400b the user 402 performs a hand gesture associated with a command for initiating a messaging application (represented by messaging user interface 412); the wrist-wearable device 426 detects the hand gesture; and, based on a determination that the user 402 is wearing the AR device 428, causes the AR device 428 to present a messaging user interface 412 of the messaging application. The AR device 428 can present the messaging user interface 412 to the user 402 via its display (e.g., as shown by user 402's field of view 410). In some embodiments, the application is initiated and can be run on the device (e.g., the wrist-wearable device 426, the AR device 428, and/or the HIPD 442) that detects the user input to initiate the application, and the device provides another device operational data to cause the presentation of the messaging application. For example, the wrist-wearable device 426 can detect the user input to initiate a messaging application, initiate and run the messaging application, and provide operational data to the AR device 428 and/or the HIPD 442 to cause presentation of the messaging application. Alternatively, the application can be initiated and run at a device other than the device that detected the user input. For example, the wrist-wearable device 426 can detect the hand gesture associated with initiating the messaging application and cause the HIPD 442 to run the messaging application and coordinate the presentation of the messaging application.

Further, the user 402 can provide a user input provided at the wrist-wearable device 426, the AR device 428, and/or the HIPD 442 to continue and/or complete an operation initiated at another device. For example, after initiating the messaging application via the wrist-wearable device 426 and while the AR device 428 presents the messaging user interface 412, the user 402 can provide an input at the HIPD 442 to prepare a response (e.g., shown by the swipe gesture performed on the HIPD 442). The user 402's gestures performed on the HIPD 442 can be provided and/or displayed on another device. For example, the user 402's swipe gestures performed on the HIPD 442 are displayed on a virtual keyboard of the messaging user interface 412 displayed by the AR device 428.

In some embodiments, the wrist-wearable device 426, the AR device 428, the HIPD 442, and/or other communicatively coupled devices can present one or more notifications to the user 402. The notification can be an indication of a new message, an incoming call, an application update, a status update, etc. The user 402 can select the notification via the wrist-wearable device 426, the AR device 428, or the HIPD 442 and cause presentation of an application or operation associated with the notification on at least one device. For example, the user 402 can receive a notification that a message was received at the wrist-wearable device 426, the AR device 428, the HIPD 442, and/or other communicatively coupled device and provide a user input at the wrist-wearable device 426, the AR device 428, and/or the HIPD 442 to review the notification, and the device detecting the user input can cause an application associated with the notification to be initiated and/or presented at the wrist-wearable device 426, the AR device 428, and/or the HIPD 442.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 428 can present to the user 402 game application data and the HIPD 442 can use a controller to provide inputs to the game. Similarly, the user 402 can use the wrist-wearable device 426 to initiate a camera of the AR device 428, and the user can use the wrist-wearable device 426, the AR device 428, and/or the HIPD 442 to manipulate the image capture (e.g., zoom in or out, apply filters) and capture image data.

While an AR device 428 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 4C-1 and 4C-2, the user 402 is shown wearing the wrist-wearable device 426 and an MR device 432 (e.g., a device capable of providing either an entirely VR experience or an MR experience that displays object(s) from a physical environment at a display of the device) and holding the HIPD 442. In the third MR system 400c, the wrist-wearable device 426, the MR device 432, and/or the HIPD 442 are used to interact within an MR environment, such as a VR game or other MR/VR application. While the MR device 432 presents a representation of a VR game (e.g., first MR game environment 420) to the user 402, the wrist-wearable device 426, the MR device 432, and/or the HIPD 442 detect and coordinate one or more user inputs to allow the user 402 to interact with the VR game.

In some embodiments, the user 402 can provide a user input via the wrist-wearable device 426, the MR device 432, and/or the HIPD 442 that causes an action in a corresponding MR environment. For example, the user 402 in the third MR system 400c (shown in FIG. 4C-1) raises the HIPD 442 to prepare for a swing in the first MR game environment 420. The MR device 432, responsive to the user 402 raising the HIPD 442, causes the MR representation of the user 422 to perform a similar action (e.g., raise a virtual object, such as a virtual sword 424). In some embodiments, each device uses respective sensor data and/or image data to detect the user input and provide an accurate representation of the user 402's motion. For example, image sensors (e.g., SLAM cameras or other cameras) of the HIPD 442 can be used to detect a position of the HIPD 442 relative to the user 402's body such that the virtual object can be positioned appropriately within the first MR game environment 420; sensor data from the wrist-wearable device 426 can be used to detect a velocity at which the user 402 raises the HIPD 442 such that the MR representation of the user 422 and the virtual sword 424 are synchronized with the user 402's movements; and image sensors of the MR device 432 can be used to represent the user 402's body, boundary conditions, or real-world objects within the first MR game environment 420.

In FIG. 4C-2, the user 402 performs a downward swing while holding the HIPD 442. The user 402's downward swing is detected by the wrist-wearable device 426, the MR device 432, and/or the HIPD 442 and a corresponding action is performed in the first MR game environment 420. In some embodiments, the data captured by each device is used to improve the user's experience within the MR environment. For example, sensor data of the wrist-wearable device 426 can be used to determine a speed and/or force at which the downward swing is performed and image sensors of the HIPD 442 and/or the MR device 432 can be used to determine a location of the swing and how it should be represented in the first MR game environment 420, which, in turn, can be used as inputs for the MR environment (e.g., game mechanics, which can use detected speed, force, locations, and/or aspects of the user 402's actions to classify a user's inputs (e.g., user performs a light strike, hard strike, critical strike, glancing strike, miss) or calculate an output (e.g., amount of damage)).

FIG. 4C-2 further illustrates that a portion of the physical environment is reconstructed and displayed at a display of the MR device 432 while the MR game environment 420 is being displayed. In this instance, a reconstruction of the physical environment 446 is displayed in place of a portion of the MR game environment 420 when object(s) in the physical environment are potentially in the path of the user (e.g., a collision with the user and an object in the physical environment are likely). Thus, this example MR game environment 420 includes (i) an immersive VR portion 448 (e.g., an environment that does not have a corollary counterpart in a nearby physical environment) and (ii) a reconstruction of the physical environment 446 (e.g., table 429 and cup 451). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 426, the MR device 432, and/or the HIPD 442 are described as detecting user inputs, in some embodiments, user inputs are detected at a single device (with the single device being responsible for distributing signals to the other devices for performing the user input). For example, the HIPD 442 can operate an application for generating the first MR game environment 420 and provide the MR device 432 with corresponding data for causing the presentation of the first MR game environment 420, as well as detect the user 402's movements (while holding the HIPD 442) to cause the performance of corresponding actions within the first MR game environment 420. Additionally or alternatively, in some embodiments, operational data (e.g., sensor data, image data, application data, device data, and/or other data) of one or more devices is provided to a single device (e.g., the HIPD 442) to process the operational data and cause respective devices to perform an action associated with processed operational data.

In some embodiments, the user 402 can wear a wrist-wearable device 426, wear an MR device 432, wear smart textile-based garments 438 (e.g., wearable haptic gloves), and/or hold an HIPD 442 device. In this embodiment, the wrist-wearable device 426, the MR device 432, and/or the smart textile-based garments 438 are used to interact within an MR environment (e.g., any AR or MR system described above in reference to FIGS. 4A-4B). While the MR device 432 presents a representation of an MR game (e.g., second MR game environment 420) to the user 402, the wrist-wearable device 426, the MR device 432, and/or the smart textile-based garments 438 detect and coordinate one or more user inputs to allow the user 402 to interact with the MR environment.

In some embodiments, the user 402 can provide a user input via the wrist-wearable device 426, an HIPD 442, the MR device 432, and/or the smart textile-based garments 438 that causes an action in a corresponding MR environment. In some embodiments, each device uses respective sensor data and/or image data to detect the user input and provide an accurate representation of the user 402's motion. While four different input devices are shown (e.g., a wrist-wearable device 426, an MR device 432, an HIPD 442, and a smart textile-based garment 438) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 438) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 438 can be used in conjunction with an MR device and/or an HIPD 442.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 4A-4C-2 provided above are intended to augment the description provided in reference to FIGS. 1A-2C. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A system, comprising:
a wearable device that includes a set of electrodes that are configured to:
contact a first portion of a user while the wearable device is being worn by the user, and
apply a haptic signal to a first portion of a user, wherein the haptic signal is configured to cause haptic feedback to be perceived at a second portion of the user that is distinct from the first portion of the user; and
a head-wearable device configured to provide an indication to the user that the haptic feedback is to be perceived at the second portion of the user.

2. The system of claim 1, wherein the haptic signal comprises:
a first subsignal having a first polarity, a first amplitude, and a first length; and
a second subsignal having:
a second polarity, the second polarity opposite the first polarity;
a second amplitude, the second amplitude larger than the first amplitude; and
a second length, the second length shorter than the first length.

3. The system of claim 2, wherein the first subsignal is configured to be imperceptible by the user.

4. The system of claim 3, wherein the second subsignal is configured to be perceptible by the user.

5. The system of claim 1, wherein the haptic signal is an electrical current generated at the wearable device.

6. The system of claim 1, wherein the first portion of the user corresponds to a wrist of the user, and wherein the second portion of the user corresponds to a hand of the user.

7. The system of claim 1, wherein the head-wearable device further includes a display, and wherein the indication provided to the user is an interface element displayed via the display of the head-wearable device.

8. The system of claim 7, wherein the first portion of the user and the second portion of the user are displayed on the display of the wearable device and the indication is positioned to visually overlap with the second portion of the user.

9. The system of claim 1, wherein each electrode of the set of electrodes is composed of a synthetic conductive elastomer.

10. The system of claim 1, wherein the set of electrodes are arranged and configured to selectively apply haptic signals to respective nerves of a set of nerves of the user.

11. The system of claim 10, wherein the set of electrodes comprise electrodes having differing sizes.

12. The system of claim 1, wherein the wearable device is further configured to apply, via the set of electrodes, a second haptic signal to the first portion of a user, wherein the second haptic signal is configured to cause second haptic feedback to be perceived at a third portion of the user that is distinct from the first portion of the user and the second portion of the user.

13. The system of claim 1, wherein the wearable device is configured to apply the haptic signal in response to a determination that the second portion of the user is intersects with a virtual object.

14. A method of providing remote haptic feedback, the method comprising:
applying, via a set of electrodes of a wearable device, a haptic signal to a first portion of a user, wherein the haptic signal is configured to cause haptic feedback to be perceived at a second portion of the user that is distinct from the first portion of the user; and
causing a visual indication of the haptic feedback at the second portion to be displayed to the user via a display of a head-wearable device.

15. The method of claim 14, further comprising, prior to applying the haptic signal, applying a priming signal to the first portion of the user, wherein the priming signal is configured to be imperceptible to the user.

16. The method of claim 15, wherein the priming signal has an opposite polarity as the haptic signal.

17. The method of claim 14, further comprising applying, via the set of electrodes of the wearable device, a second haptic signal to the first portion of a user, wherein the second haptic signal is configured to cause second haptic feedback to be perceived at a third portion of the user that is distinct from the first portion of the user and the second portion of the user.

18. A non-transitory computer-readable storage medium storing one or more programs executable by one or more processors, the one or more programs comprising instructions for:
applying, via a set of electrodes of a wearable device, a haptic signal to a first portion of a user, wherein the haptic signal is configured to cause haptic feedback to be perceived at a second portion of the user that is distinct from the first portion of the user; and
causing a visual indication of the haptic feedback at the second portion to be displayed to the user via a display of a head-wearable device.

19. The non-transitory computer-readable storage medium of claim 18, wherein the one or more programs further include instructions for:
prior to applying the haptic signal, displaying, via the display of the head-wearable device, a virtual object; and
wherein the haptic signal is applied to the first portion of the user in accordance with a determination that the second portion of the user's hand intersects with the virtual object.

20. The non-transitory computer-readable storage medium of claim 19, wherein the one or more programs further include instructions for:
in accordance with a determination that the user is grasping the virtual object using a first finger corresponding to the second portion of the user's hand and a thumb corresponding to a third portion of the user's hand:
applying a second haptic signal to the first portion of the user, wherein the second haptic signal is configured to cause second haptic feedback to be perceived at the third portion of the user; and
causing a second visual indication of the second haptic feedback at the third portion to be displayed to the user via the display of the head-wearable device.
